(19) United States
(12) Patent Application Publication
(10) Pub. No.: US 2021/0279033 A1
(43) Pub. Date: Sep. 9, 2021

(54) SECURE LOUDSPEAKER MICROPHONE SYSTEMS AND LOUDSPEAKERS CONTAINING SAME

(71) Applicant: Clean Energy Labs, LLC, Austin, TX (US)

(72) Inventors: Joseph F. Pinkerton, Austin, TX (US); David A. Badger, Lago Vista, TX (US)

(73) Assignee: Clean Energy Labs, LLC, Austin, TX (US)

(21) Appl. No.: 17/192,542

(22) Filed: Mar. 4, 2021

Related U.S. Application Data
(60) Provisional application No. 62/985,972, filed on Mar. 6, 2020.

(51) Int. Cl. G06F 3/16; H04R 1/26; H04R 1/40; H04R 3/12; H04R 19/02; H04R 17/00; H04R 1/08; H04R 3/00

(52) U.S. Cl. CPC G06F 3/165; H04R 1/26; H04R 1/403; H04R 3/12; H04R 3/005; H04R 17/00; H04R 1/08; H04R 1/406; H04R 19/02

(57) ABSTRACT

Audio devices that have microphones, and particularly to secure loudspeaker microphone systems and loudspeakers that have and use same. The device includes a loudspeaker, one or more microphones, a first mute switch for turning on and off the one or more microphones via software or electrical circuitry, and a second mute switch that is an electromechanical switch that removes all power to the one or more microphones.

### RELATED PATENTS/PATENT APPLICATIONS

This application claims priority to U.S. Patent Appl. Ser. No. 62/985,972, filed Mar. 6, 2020, to Joseph F. Pinkerton et al, and entitled “Secure Loudspeaker Microphone Systems And Loudspeakers Containing Same.”

This application is related to International Patent Application No. PCT/US20/59634, filed Nov. 9, 2020, to Joseph F. Pinkerton et al., entitled “Electroacoustic Drivers And Loudspeakers Containing Same,” (the “Pinkerton PCT '634 Application”).

This application is also related to International Patent Application No. PCT/US19/30438, filed May 2, 2019, to Joseph F. Pinkerton et al., entitled “Loudspeaker System And Method Of Use Thereof,” (the “Pinkerton PCT '438 Patent Application”).

This application is also related to U.S. Pat. No. 9,826,313, issued Nov. 21, 2017, to Joseph F. Pinkerton et al., and entitled “Compact Electroacoustic Transducer And Loudspeaker System And Method Of Use Thereof,” (the “Pinkerton '313 Patent”).

This application is also related to International Patent Application No. PCT/US19/057871, filed Oct. 24, 2019, to David A Badger et al., entitled “Stereophonic Loudspeaker System And Method Of Use Thereof,” (the “Badger PCT '871 Patent Application”).

All of the above-identified patent applications are commonly assigned to the Assignee of the present invention and are hereby incorporated herein by reference in their entirety for all purposes.

### TECHNICAL FIELD

The present invention relates to audio devices that have microphones, and particularly to secure loudspeaker microphone systems and loudspeakers that have and use same.

### BACKGROUND

Today's loudspeakers are devices that stream audio content, and often do so from a wireless source. A relatively new class of “smart” loudspeaker devices, such as Google's Home devices and Amazon's Echo devices, also contain voice-activated assistants. These Google and Amazon devices have AI voice assistance command features via Google Assistant software and Amazon Alexa Voice Services software. Such smart devices thus have microphones so that users can interact with them via the voice assistance software.

On these smart devices, a user has the option to activate a “mute” microphone feature via a button or sliding switch. However, some of these mute switches are currently used to activate a software command; and, thus, it remains plausible that the device can still be recording utilizing the microphone. Moreover, for software-based mute buttons, a third party could potentially hack into the system to “listen” to the user's conversations, even when the user believes that the microphone is muted. Other mute buttons use a mechanical switch that activates an electrical circuit to cut power to the smart device microphones. While this type of circuit is more secure than software-based mic must systems, some users still doubt that their conversations are private with this type of mute system. Other smart devices use a sliding electromechanical switch to cut all power to the device's microphones with no need for additional electrical components. These sliding electromechanical switches give users confidence that their conversations are private but these switches are often relatively difficult to operate and determine when they are on or off.

Accordingly, there is a need in the art for microphone mute systems on loudspeakers that include a first mic mute system that is easy to operate and a second mic mute system that is fully secure for use with smart speakers (and other smart devices having microphones), such as the devices disclosed and described in the Pinkerton PCT '634 Patent Application, the Pinkerton PCT '438 Patent Application, Pinkerton '313 Patent, and the Badger PCT '871 Patent Application (collectively, the “Pinkerton Patents/Patent Applications”) as well as other loudspeaker devices.

### SUMMARY OF THE INVENTION

The present invention relates to secure loudspeaker microphone systems and loudspeakers that have and use same.

In general, in one aspect, the invention features a device that includes one or more loudspeakers, one or more microphones, a plurality of buttons to control the one or loudspeakers, and a second microphone mute switch that is an electromechanical switch. One of the buttons in the plurality of buttons is a mute button that is operable to turn on and off a first microphone mute switch. The first microphone mute switch includes (A) a software-based microphone mute switch or (B) a mechanical switch in combination with electrical circuitry. When the first microphone mute switch is turned on, software or electrical circuitry in the device is operable for preventing audible content from being transmitted outside of the device. The second microphone mute switch can be moved between a mute off position and a mute on position. When the second microphone mute switch is in the mute on position, the second microphone mute switch mechanically prevents electrical power from being routed to the one or more microphones.

Implementations of the invention can include one or more of the following:

The first microphone switch can include the software-based microphone mute switch. When the software-based microphone mute switch is turned on, software in the device can be operable for preventing audible content from being transmitted outside of the device.

The first microphone switch can include the mechanical switch in combination with the electrical circuitry. When the mechanical switch is turned on, electrical circuitry in the device can be operable for preventing audible content from being transmitted outside of the device.

The second microphone mute switch can be a sliding switch that slides between the mute off position and the mute on position.

The mute button can be operable to illuminate when the first microphone mute switch is turned on, the second microphone mute switch is in the mute on position, or both.

The mute button can be operable to not illuminate when the first microphone mute switch is turned off and the second microphone mute switch is in the mute off position.

The device can be operable to emit an audible signal or message if the mute button is depressed while the second microphone mute switch is in the mute on position.

The device can be operable to emit an audible signal or message if the mute button is depressed more than once in a per-determined period while the second microphone mute switch is in the mute on position.

The second microphone mute switch can be on the opposite side of the device from the mute button.

When the device is in its standard orientation, the second microphone mute switch can be on the bottom of the device.

The loudspeaker can include an array of electrostatic transducers.

The loudspeaker can be an electroacoustic loudspeaker having a bidirectional force electromagnet transducer or piezoelectric transducer.

The loudspeaker can include an electroacoustic transducer including an electrically conductive stator and an electrically conductive membrane.

The loudspeaker can include a middle section. The middle section can include one or more electro-dynamic drivers in a sealed chamber. The loudspeaker can further include a first end section located on a first side of the middle section having a first plurality of electrostatic card stack drivers. The loudspeaker can further include a second end section located on the opposing side of the middle section having a second plurality of electrostatic card stack drivers

The one or more loudspeakers can include a first loudspeaker operable for emitting audible sound in a first range between 20 Hz and an upper set point frequency. The one or more loudspeakers can include a second loudspeaker operable for emitting audible sound in a second range between a lower set point frequency and 20 kHz. The second loudspeaker can include a plurality of card stacks having electrostatic transducers. The upper set point frequency of the first range can be the same or greater than the lower set point frequency of the second range.

In general, in another aspect, the invention features a method that includes the step of selecting a device comprising one or more loudspeakers and one or more microphones. The device further includes a first microphone mute switch and a second microphone mute switch. The first microphone mute switch includes (A) a software-based microphone mute switch or (B) a mechanical switch in combination with electrical circuitry. The second microphone mute switch is an electromechanical switch. The method further includes that, when the one or more microphones are not muted, muting the one or more microphones by pressing a mute button on the device to turn the first microphone mute switch on. The method further includes that, when the one or more microphones are not muted, muting the one or more microphones by switching the second microphone mute switch to the mute on position.

Implementations of the invention can include one or more of the following:

The method can include that, when the one or more microphones are muted because the first microphone mute switch is on while the second microphone mute switch is in a mute off position, un-muting the one or more microphones by pressing the mute button on the device to turn the first microphone mute switch off. The method can include that, when the one or more microphones are muted because the second microphone mute switch is in a mute on position while the first microphone mute switch is off, un-muting the one or more microphones by switching the second microphone mute switch to the mute off position The method can include that, when the one or more microphones are muted because the first microphone mute switch is on and because the second microphone mute switch is in a mute on position, un-muting the one or more microphones by (i) switching the second microphone mute switch to the mute off position, and (ii) pressing the mute button on the device to turn the first microphone mute switch off.

The first microphone switch can include the software-based microphone mute switch. Pressing the mute button on the device to turn the first microphone mute switch off can operate the software in the device to prevent audible content from being transmitted outside of the device.

The first microphone switch can include the mechanical switch in combination with the electrical circuitry. Pressing the mute button on the device to turn the first microphone mute switch off can operate the electrical circuitry to prevent audible content from being transmitted outside of the device.

The step of switching the second microphone mute switch to the mute on position can include sliding the second microphone mute switch from the mute off position to the mute on position.

The mute button can illuminate when the first microphone mute switch is turned on, the second microphone mute switch is in the mute on position, or both.

The mute button can cease illuminating when the first microphone mute switch is turned off and the second microphone mute switch is in the mute off position.

The device can emit an audible signal or message when the mute button is depressed while the second microphone mute switch is in the mute on position.

The device can emit an audible signal or message when the mute button is depressed more than once in a per-determined period while the second microphone mute switch is in the mute on position.

The second microphone mute switch can be on the opposite side of the device from the mute button.

When the device is in its standard orientation, the second microphone mute switch can be on the bottom of the device.

The loudspeaker can include an array of electrostatic transducers.

### DESCRIPTION OF DRAWINGS

FIG. 1A is a photograph of a top perspective view of a loudspeaker that is embodiment of the present invention.

FIG. 1B is a close-up of the top-side buttons of the loudspeaker shown in FIG. 1A.

FIGS. 2A-2B are photographs of the bottom of the loudspeaker shown in FIG. 1A. which show a mechanical microphone mute switch in the “off” and “on” position, respectively.

### DETAILED DESCRIPTION

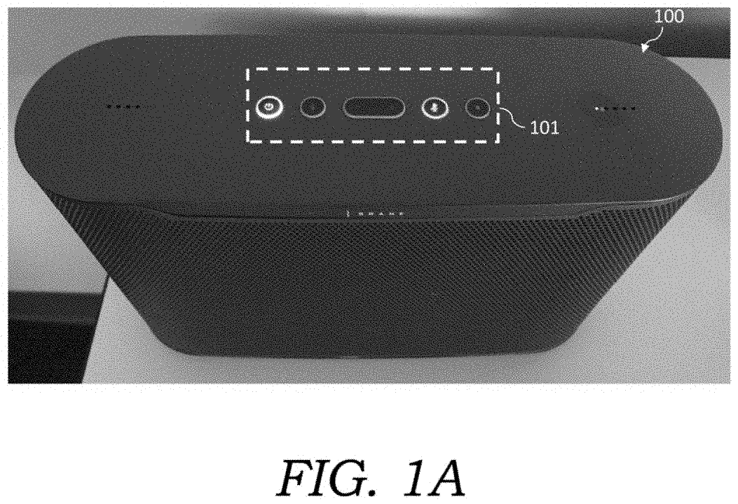

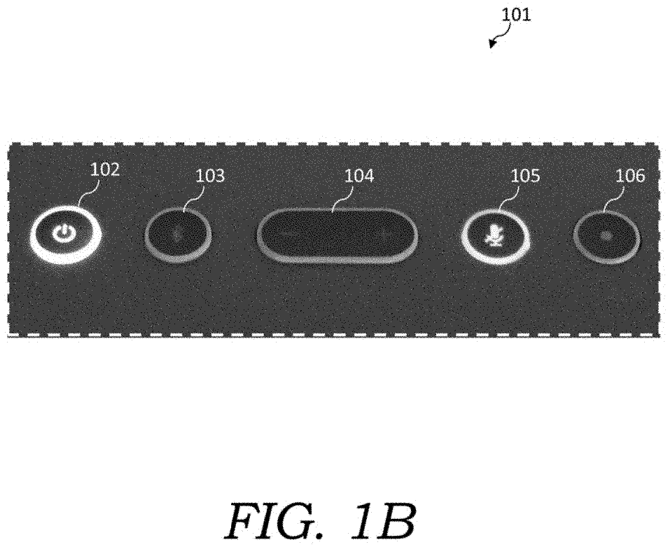

The present invention relates to audio devices that have microphones, and particularly to secure loudspeaker microphone systems and loudspeakers that have and use same. FIG. 1A shows a perspective view of the top of a loudspeaker device 100, such as the loudspeaker devices disclosed and taught in the Pinkerton Patents/Patent Applications. Loudspeaker device 100 has various control buttons, which are outlined by box 101. FIG. 1B shows a magnified view of the various control buttons in box 101. These control buttons are power button 102, Bluetooth connection button 103, volume control button 104 (with “+” and “−” indicating the direction of control), microphone mute button 105, and action button 106.

As shown in FIGS. 1A-1B, power button 102 is illuminated, which indicates that the loudspeaker device 100 is powered on.

Moreover, as shown in FIGS. 1A-1B, the microphone mute button 105 is illuminated, which means that the device has one (or both) of its microphone mute switches set in the mute “on” position. I.e., the device has its mute feature activated.

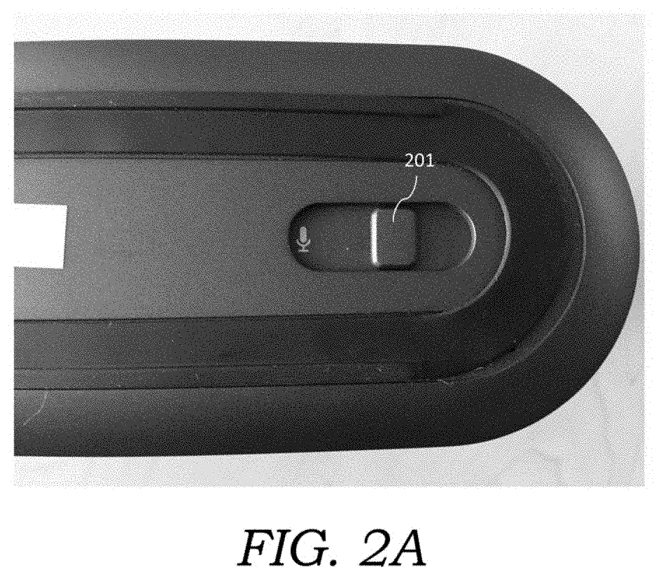

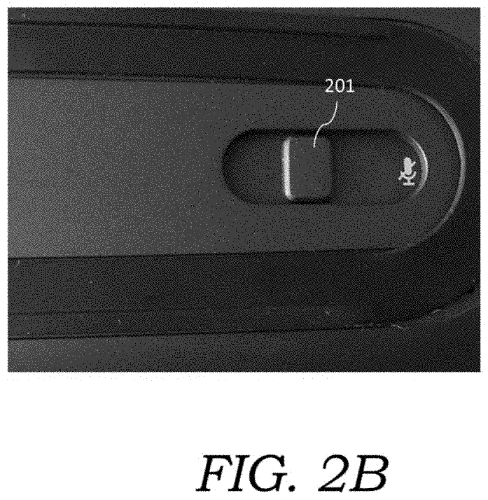

The loudspeakers of the present invention include at least two microphone mute switches. One switch is a software-based microphone mute switch (or, alternatively, a mechanical switch used in combination with electrical circuitry). The second switch is mechanical microphone mute switch 201, which is exclusively an electromechanical switch. Mechanical microphone mute switch 201 can be placed, for example, on the bottom of the device, such as shown in FIGS. 2A-2B. When the mechanical microphone mute switch 201 is in the “on” position (such that the microphone of loudspeaker device 100 is powered off and incapable of gathering any auditory information), there is a hardwire disconnect of the microphone. As shown in FIGS. 2A-2B. the mechanical microphone mute switch 201 can be slid back and forth between the “mute off” position shown in FIG. 2A to the “mute on” position shown in FIG. 2B. For clarity, the “mute off” position means that the mechanical microphone mute switch 201 is not set to mute the microphone, while the “mute on” position means that mechanical microphone mute switch 201 is mechanically set to mute the microphone (and will do so regardless of the software microphone mute switch).

For example, in embodiments of the present invention, by setting the mechanical microphone mute switch 201 in the “mute on” position (such as shown in FIG. 2B), this removes all power running to the microphone Mechanical microphone mute switch 201 cannot be circumvented remotely, and it is impossible to hack loudspeaker device 100 to disengage this mute feature.

If either the mechanical microphone mute switch 201 or the software mute switch is “on,” microphone mute button 105 will illuminated, such as shown in FIG. 1B.

When the microphone is on (and not muted), the user may opt to activate the mute feature by pressing the microphone mute button 105, which will activate the software microphone mute switch. Alternately, a voice command can be used to turn on the software-based mic mute switch. Either of these actions will then illuminate microphone mute button 105. In such state, the microphone can be easily turned back on (i.e., mute disengaged) by pressing microphone mute button 105 again or, optionally, through a voice command (in this case, a secondary “wake word” for this feature must differ from the primary wake word so that mic mute voice commands do not activate the primary voice service). Microphone mute button 105 would then not be illuminated. Many users will be satisfied with this level of privacy and the operation of mute button 105 is easy to implement and view.

Alternatively, a user who desires a higher level of privacy may opt to activate a second mic mute feature by sliding mechanical microphone mute switch 201 to the “on” position. Sliding mechanical microphone mute switch 201 to the “on” position will then illuminate microphone mute button 105. To deactivate the mechanical microphone mute switch 201, the user will have to slide the mechanical microphone mute switch 201 back to the “off” position. Pushing on microphone mute button 105 will not deactivate the mechanical microphone mute switch 201.

Optionally, in some embodiments of the present invention, if a user pushes microphone mute button 105 more than once or uses a secondary wake word in an attempt to deactivate the mute feature (but fails because the mechanical microphone mute switch 201 is in the “on” position), the loudspeaker device 100 can emit an audible signal or message to the user that the mechanical microphone mute switch 201 is still activated. For example, loudspeaker device 100 can inform the user to “please turn off the mic mute switch on the bottom of the speaker.” The user can then act accordingly to deactivate the mechanical microphone mute switch 201, if so desired.

While mechanical microphone mute switch 201 turns off all power running to the microphone, this allows for the loudspeaker device 100 to continue to be powered on and be used, such as to emit audio signals. Thus, a user can still utilize loudspeaker device 100, such as to play music, without concern that the microphone could be hacked or otherwise on and receiving (and recording) audio information.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only li e numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±0%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±10° of the perpendicular and parallel directions, respectively, in some embodiments within ±5° of the perpendicular and parallel directions, respectively, in some embodiments within ±1° of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C. and D individually, but also includes any and all combinations and subcombinations of A, B, C, and D.

What is claim is:

1. A device comprising:
(a) one or more loudspeakers,
(b) one or more microphones,
(c) a plurality of buttons to control the one or loudspeakers, wherein
(i) one of the buttons in the plurality of buttons is a mute button that is operable to turn on and off a first microphone mute switch,
(ii) the first microphone mute switch comprises (A) a software-based microphone mute switch or (B) a mechanical switch in combination with electrical circuitry, and
(iii) when the first microphone mute switch is turned on, software or electrical circuitry in the device is operable for preventing audible content from being transmitted outside of the device; and
(d) a second microphone mute switch that is an electromechanical switch, wherein
(i) the second microphone mute switch can be moved between a mute off position and a mute on position and;
(ii) when the second microphone mute switch is in the mute on position, the second microphone mute switch mechanically prevents electrical power from being routed to the one or more microphones.

2. The device of claim 1, wherein
(a) the first microphone switch comprises the software-based microphone mute switch; and
(b) when the software-based microphone mute switch is turned on, software in the device is operable for preventing audible content from being transmitted outside of the device.

3. The device of claim 1, wherein
(a) the first microphone switch comprises the mechanical switch in combination with the electrical circuitry; and
(b) when the mechanical switch is turned on, electrical circuitry in the device is operable for preventing audible content from being transmitted outside of the device.

4. The device of claim 1, wherein the second microphone mute switch is a sliding switch that slides between the mute off position and the mute on position.

5. The device of claim 1, wherein the mute button is operable to illuminate when the first microphone mute switch is turned on, the second microphone mute switch is in the mute on position, or both.

6. The device of claim 5, wherein the mute button is operable to not illuminate when the first microphone mute switch is turned off and the second microphone mute switch is in the mute off position.

7. The device of claim 1, wherein the device is operable to emit an audible signal or message if the mute button is depressed while the second microphone mute switch is in the mute on position.

8. The device of claim 1, wherein the device is operable to emit an audible signal or message if the mute button is depressed more than once in a per-determined period while the second microphone mute switch is in the mute on position.

9. The device of claim 1, wherein the second microphone mute switch is on the opposite side of the device from the mute button.

10. The device of claim 1, wherein, when the device is in its standard orientation, the second microphone mute switch is on the bottom of the device.

11. The device or claim 1, wherein the loudspeaker comprises an array of electrostatic transducers

12. The device of claim 1, wherein the loudspeaker is an electroacoustic loudspeaker having a bidirectional force electromagnet transducer or piezoelectric transducer.

13. The device of claim 1, wherein the loudspeaker comprises an electroacoustic transducer comprising an electrically conductive stator and an electrically conductive membrane.

14. The device of claim 1, wherein the loudspeaker comprises
(a) a middle section comprising one or more electro-dynamic drivers in a sealed chamber,
(b) a first end section located on a first side of the middle section having a first plurality of electrostatic card stack drivers; and
(c) a second end section located on the opposing side of the middle section having a second plurality of electrostatic card stack drivers.

15. The device of claim 1, wherein the one or more loudspeakers comprise:
(a) a first loudspeaker operable for emitting audible sound in a first range between 20 Hz and an upper set point frequency; and
(b) a second loudspeaker operable for emitting audible sound in a second range between a lower set point frequency and 20 kHz, wherein
(i) the second loudspeaker comprises a plurality of card stacks having electrostatic transducers, and
(ii) the upper set point frequency of the first range is the same or greater than the lower set point frequency of the second range.

16. A method comprising:
(a) selecting a device comprising one or more loudspeakers and one or more microphones, wherein the device further comprises a first microphone mute switch and a second microphone mute switch, wherein
(i) the first microphone mute switch comprises (A) a software-based microphone mute switch or (B) a mechanical switch in combination with electrical circuitry, and
(ii) the second microphone mute switch is an electromechanical switch;
(b) when the one or more microphones are not muted, muting the one or more microphones by pressing a mute button on the device to turn the first microphone mute switch on; and
(c) when the one or more microphones are not muted, muting the one or more microphones by switching the second microphone mute switch to the mute on position.

17. The method of claim 16, wherein the method further comprises:
(a) when the one or more microphones are muted because the first microphone mute switch is on while the second microphone mute switch is in a mute off position, un-muting the one or more microphones by pressing the mute button on the device to turn the first microphone mute switch off;
(b) when the one or more microphones are muted because the second microphone mute switch is in a mute on position while the first microphone mute switch is off, un-muting the one or more microphones by switching the second microphone mute switch to the mute off position; and
(c) when the one or more microphones are muted because the first microphone mute switch is on and because the second microphone mute switch is in a mute on position, un-muting the one or more microphones by
(i) switching the second microphone mute switch to the mute off position, and
(ii) pressing the mute button on the device to turn the first microphone mute switch off.

18. The method of claim 16, wherein
(a) the first microphone switch comprises the software-based microphone mute switch; and
(b) pressing the mute button on the device to turn the first microphone mute switch off operates the software in the device to prevent audible content from being transmitted outside of the device.

19. The method of claim 16, wherein
(a) the first microphone switch comprises the mechanical switch in combination with the electrical circuitry; and
(b) pressing the mute button on the device to turn the first microphone mute switch off operates the electrical circuitry to prevent audible content from being transmitted outside of the device.

20. The method of claim 16, wherein switching the second microphone mute switch to the mute on position comprises sliding the second microphone mute switch from the mute off position to the mute on position.

21. The method of claim 16, wherein the mute button illuminates when the first microphone mute switch is turned on, the second microphone mute switch is in the mute on position, or both.

22. The method of claim 21, wherein the mute button ceases illuminating when the first microphone mute switch is turned off and the second microphone mute switch is in the mute off position.

23. The method of claim 16, wherein the device emits an audible signal or message when the mute button is depressed while the second microphone mute switch is in the mute on position.

24. The method of claim 16, wherein the device emits an audible signal or message when the mute button is depressed more than once in a per-determined period while the second microphone mute switch is in the mute on position.

25. The method claim 16, wherein the second microphone mute switch is on the opposite side of the device from the mute button.

26. The method of claim 16, wherein, when the device is in its standard orientation, the second microphone mute switch is on the bottom of the device.

27. The method of claim 16, wherein the loudspeaker comprises an array of electrostatic transducers.
